(19) United States
(12) Patent Application Publication
(10) Pub. No.: US 2011/0290508 A1
(43) Pub. Date: Dec. 1, 2011

(54) FIRE SPRINKLER GUARD SYSTEM

(76) Inventor: MATTHEW D. HUNSBERGER, Granger, IN (US)

(21) Appl. No.: 13/118,870

(22) Filed: May 31, 2011

Related U.S. Application Data
(60) Provisional application No. 61/350,070, filed on Jun. 1, 2010.

(51) Int. Cl. A62C 99/00

(52) U.S. Cl. 169/51

(57) ABSTRACT

A guard for a fire-suppression sprinkler head may be attached directly to a water supply pipe of the sprinkler head. A cage may be configured to surround the sprinkler head and a base plate may be configured for attachment to the pipe. The cage may be attached to the base plate.

### RELATED APPLICATIONS

This application claims the benefit of U.S. Provisional Patent Application No. 61,350,070 filed Jun. 1, 2010.

### BACKGROUND OF THE INVENTION

The present invention generally relates to fire-suppression sprinklers and more particularly to protective devices for preventing damage to and inadvertent activation of sprinkler heads.

Fire-suppression sprinkler systems are installed in numerous buildings. In some buildings, sprinkler heads may be vulnerable to being damaged or inadvertently activated as a result of activities taking place in the building. For example, in school gymnasiums, indoor sports activities such as basketball or volleyball may result sprinkler heads being struck by balls. Sprinkler heads in these settings are typically provided with protective guards. A typical guard for a sprinkler head may be structured as a wire cage that may attach to and surround the sprinkler head. Such guards may not fully protect a sprinkler heard from a very high impact. A guard that is attached to a sprinkler head may transmit force of a high impact to the sprinkler head itself. In some instances the sprinkler head may inadvertently activate or break away from its water supply pipe.

As can be seen, there is a need for a system of guarding sprinkler heads against impact damage in a manner that does not leave a sprinkler head vulnerable to being severed from its water supply pipe.

### SUMMARY OF THE INVENTION

In one aspect of the present invention, a guard for a fire-suppression sprinkler head attached to a pipe may comprise: a cage configured to surround the sprinkler head; and a base plate configured for attachment to the pipe,

the cage being attached to the base plate.

In another aspect of the present invention, a guard for a sprinkler head mounted on an end of a pipe may comprise: a base plate; a cage attached to the base plate and configured to surround the sprinkler head; and a support member configured for attachment to the pipe with u-bolts, the base plate being attached to the support member.

In still another aspect of the invention, a guard for a sprinkler head mounted on an elbow of a pipe may comprise: a cage configured to surround the sprinkler head; and a base plate configured for attachment to the pipe with u-bolts, the cage being attached to the base plate and an outboard end of the base plate being cantilevered beyond the u-bolts.

These and other features, aspects and advantages of the present invention will become better understood with reference to the following drawings, description and claims.

### BRIEF DESCRIPTION OF THE DRAWINGS

FIG. 1 is a perspective view of a sprinkler head guard in accordance with an embodiment of the invention;

FIG. 2 is a side view of the guard of FIG. 1;

FIG. 3 is a section view of the guard of FIG. 1 taken along line 3-3 in FIG. 1;

FIG. 4 is an exploded view of the guard of FIG. 1;

FIG. 5 is a perspective of a sprinkler head guard in accordance with a second embodiment of the invention;

FIG. 6 is a side view of guard of FIG. 5;

FIG. 7 is a section view the guard of FIG. 5 taken along line 7-7 in FIG. 6.

FIG. 8 is an exploded view the guard of FIG. 5;

FIG. 9 is a perspective of a sprinkler head guard in accordance with a third embodiment of the invention;

FIG. 10 is a side view of the guard of FIG. 9; and

FIG. 11 is an exploded view of the guard of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide sprinkler head guards which are not attached to the sprinkler head but are instead attached to a water supply pipe for the sprinkler head.

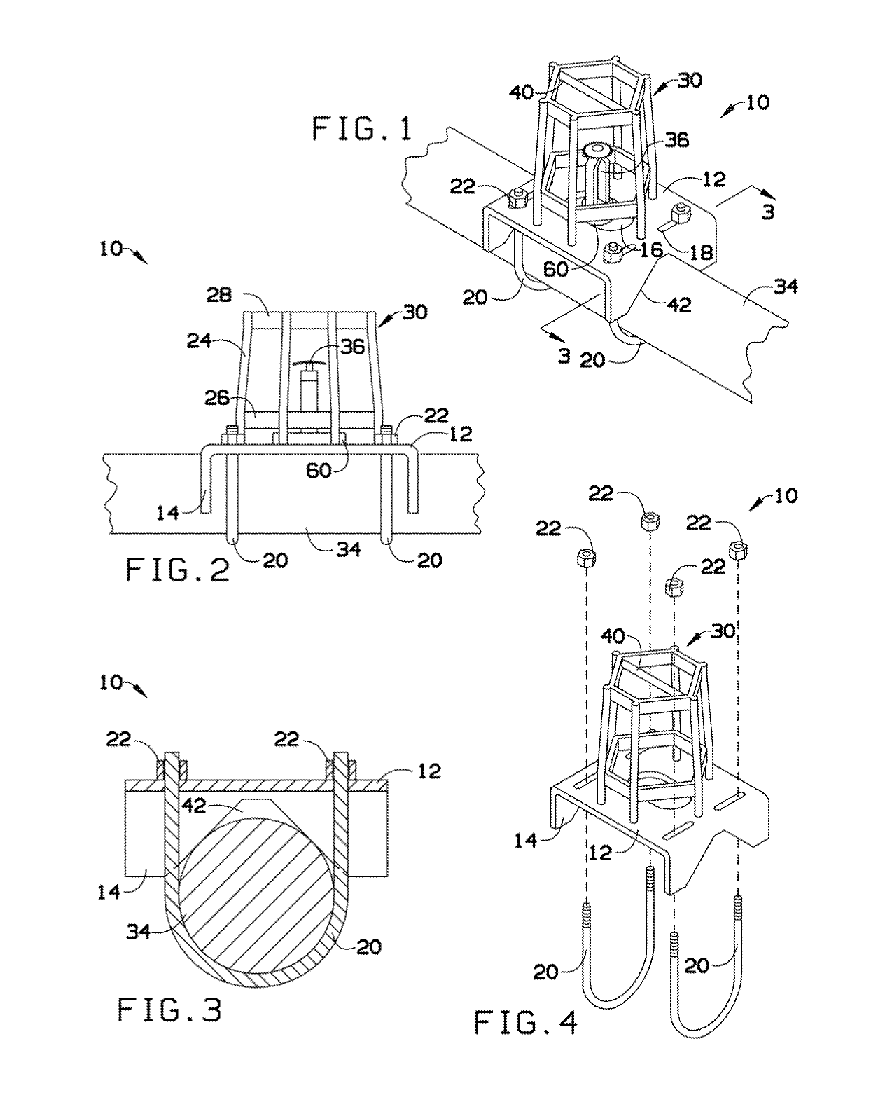

Referring now to FIGS. 1 through 4 there may be seen an exemplary embodiment of a sprinkler-head guard 10 which may be useful for application over an “in-line” sprinkler head 36. The guard 10 may comprise a base plate 12, base plate legs 14 with slip-jam joints 42, a sprinkler head hole 16, u-bolt holes 18, u-bolts 20, nylon thread-lock nuts 22 and a cage 30. The cage 30 may comprise side force-resistant bars 24, a bottom ring 26, a top ring 28 and a top force resistant bar 40. The sprinkler-head guard 10 may be attached directly to a pipe 34 which may be a water supply for the sprinkler head 36. The sprinkler head hole 16 may be configured so that it may engage with a mounting flange 60 to which the sprinkler head 36 may be attached. The guard 10 may not be in actual contact with the sprinkler head 36. Consequently, forces from impact on the guard 10 may be transmitted to the pipe 34 and the sprinkler head 36 may remain isolated from such forces. Even if a high-impact force were to displace (either longitudinally or rotationally) the guard 10 from its originally installed position, edges of the hole 16 may engage with the mounting flange 60 so that damage to the sprinkler head may be prevented.

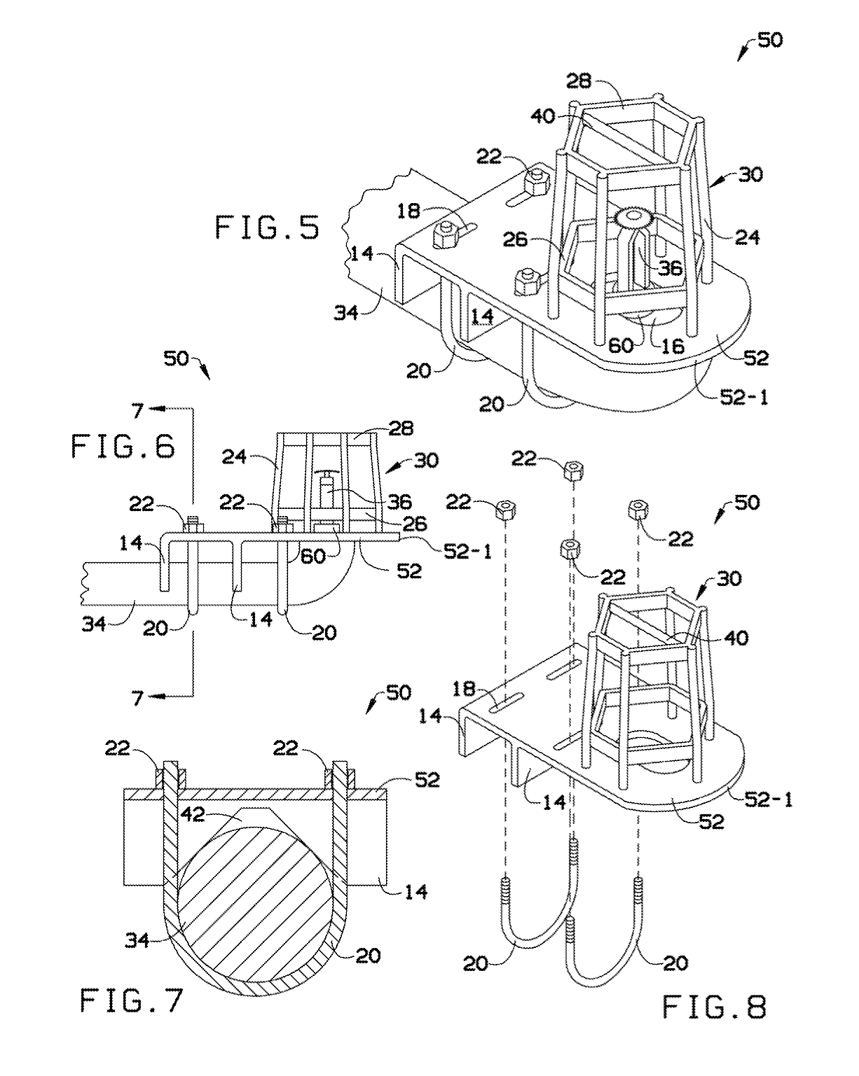

Referring now to FIGS. 5 through 8 there may be seen an exemplary embodiment of a sprinkler-head guard 50 which may be useful for application over one of the sprinkler heads 36 that may be mounted on an elbow of the pipe 34. The guard 50 may be similar to the guard 10 except that a base plate 52 may be configured differently than the base plate 12. An outboard end 52-1 of the base plate 52 may be cantilevered beyond the base plate legs 14 and the u-bolts 20.

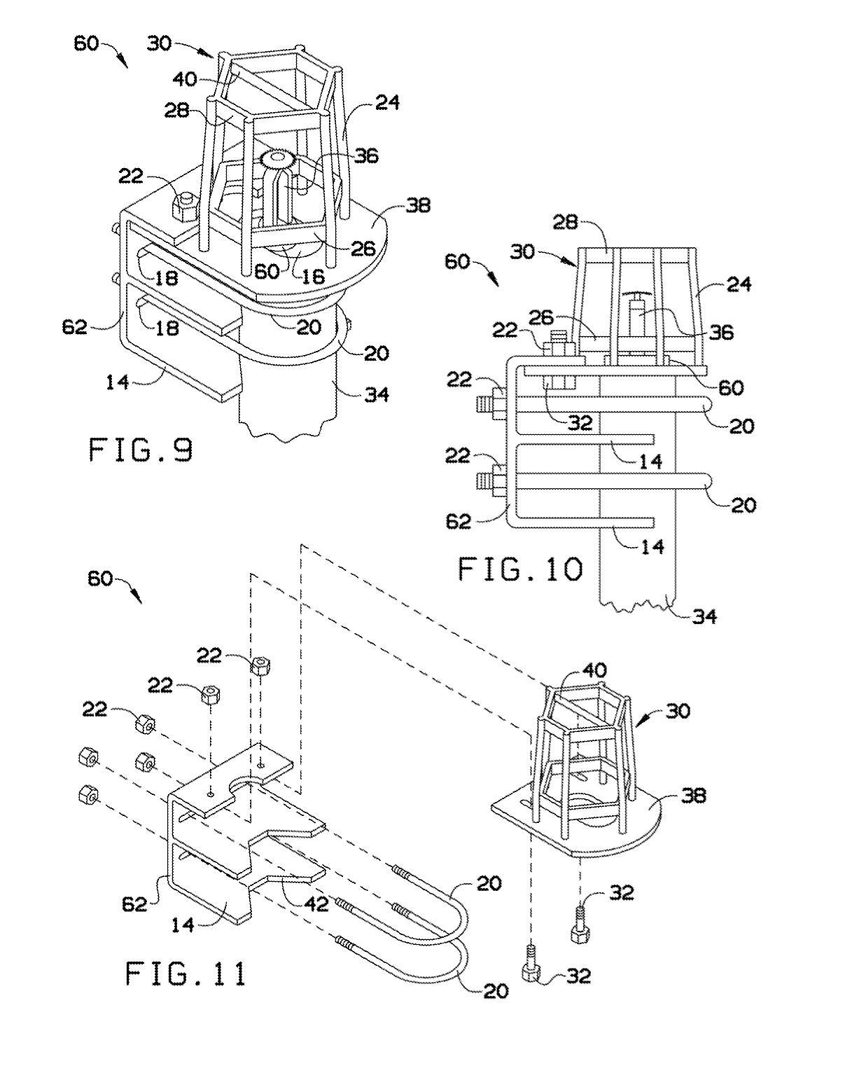

Referring now to FIGS. 9 through 11 there may be seen an exemplary embodiment of a sprinkler-head guard 60 which may be useful for application over one of the sprinkler heads 36 that may be mounted on an end of the pipe 34. The guard 50 may be similar to the guard 10 except that a base plate 38 and a support member 62 may configured to support the cage 30. The support member 62 may comprise two of the base plate legs 14 and may be held in position on the pipe 34 with two of the u-bolts 20. A base plate 38 may be bolted to the support member 62 with bolts 32.

In an exemplary embodiment, side force-resistant bars 24 may be made of steel and may be about 4½ inch long and ¼ inch in diameter. The side force-resistant bars 24 may be bent at an angle of 22 degrees inward from the bottom ring 26. The bottom ring 26 may have a 4½″ outer diameter and may measure 3/16 inch in thickness and may be ½ inch wide. The bottom ring 26 may be centered over the sprinkler head hole 16 may be welded just below the 22 degree angle on the inside of the side force-resistant bars 24. The top ring 28 may have a 3½ inch outer diameter and may measure 3/16 inch in thickness and may be ½ inch wide. The top ring 28 may be centered over the sprinkler head hole 16 and may be welded just inside and flush with uppermost ends of the side force-resistant bars 24. The top force resistant bar 40 may measure 3 inch in length and can be ¼ inch in diameter. The top force-resistant bar 40 may be welded in line with two of the side force-resistant bars 24, inside the top ring 28.

The steel force-resistant bars 24 may be welded to the bottom ring 26 and top ring 28 in such a way as to prevent anything the size of a tennis ball or larger from coming into contact with the sprinkler head 36 and causing activation of the sprinkler system. The top force-resistant bar 40 may be configured as to not allow anything the size of a golf ball or larger from coming into contact with the sprinkler head 36.

It should be understood, of course, that the foregoing relates to exemplary embodiments of the invention and that modifications may be made without departing from the spirit and scope of the invention as set forth in the following claims.

What is claimed is:

1. A guard for a fire-suppression sprinkler head attached to a pipe, comprising:
a cage configured to surround the sprinkler head; and
a base plate configured for attachment to the pipe,
the cage being attached to the base plate.

2. The guard of claim 1 wherein the base plate has a sprinkler head hole therein configured to be engageable with a mounting flange on which the sprinkler head is attached.

3. The guard of claim 1 further comprising:
base plate support legs with slip-jam joints; and
u-bolts configured to partially encircle the pipe and secure the slip-jam joints against the pipe.

4. The guard of claim 1 wherein the cage comprises:
a top ring;
a bottom ring; and
a plurality of force-resistant bars interposed between the top ring and the bottom ring.

5. The guard of claim 4 wherein the force resistant bars are angled inwardly.

6. The guard of claim 4 further comprising a top force-resistant bar attached to the top ring.

7. A guard for a sprinkler head mounted on an end of a pipe, comprising:
a base plate;
a cage attached to the base plate and configured to surround the sprinkler head; and
a support member configured for attachment to the pipe with u-bolts,
the base plate being attached to the support member.

8. The guard of claim 7 wherein the base plate is attached to the support member with bolts.

9. A guard for a sprinkler head mounted on an elbow of a pipe, comprising:
a cage configured to surround the sprinkler head; and
a base plate configured for attachment to the pipe with u-bolts,
the cage being attached to the base plate; and
an outboard end of the base plate being cantilevered beyond the u-bolts.

10. The guard of claim 7 wherein the base plates comprises integral base plate support legs and the outboard end of the base plate is cantilevered beyond the base plate support legs.
